(19) United States
(12) Patent Application Publication
(10) Pub. No.: US 2018/0162774 A1
(43) Pub. Date: Jun. 14, 2018

(54) METHOD TO PRODUCE AGGREGATES FROM UNSETTLED CEMENTITIOUS MIXTURES

(71) Applicant: CEMEX RESEARCH GROUP AG, Brugg bei Biel (CH)

(72) Inventors: Davide ZAMPINI, Lyss (CH); Alexandre GUERINI, Cressier NE (CH); Giovanni VOLPATTI, Aegerten (BE) (CH)

(21) Appl. No.: 15/580,386

(22) PCT Filed: Jun. 7, 2016
(86) PCT No.: PCT/EP2016/062868

§ 371 Date: Dec. 7, 2017

(30) Foreign Application Priority Data
Jun. 8, 2015 (EP) PCT/EP2015/062689

(51) Int. Cl. C04B 18/02; C04B 24/02; C04B 24/12; C04B 24/26; C04B 24/38

(52) U.S. Cl. CPC C04B 18/021; C04B 24/02; C04B 24/121; C04B 24/383; C04B 24/2641; C04B 24/2652; C04B 24/2623

(57) ABSTRACT

Method to produce aggregates from unsettled cementitious mixtures, comprising the steps of (a) adding at least one pelletizing agent to an unsettled cementitious mixture, (b) mixing constantly the mixture of step (a) in a mixer to produce pellets, (c) discharging the pellets obtained in step (b) and (d) drying the pellets formed in step (c). The pelletizing agent is selected from the group consisting of cellulose, chitosan, collagen, polyacrylamide and co-polymers of polyacrylamide and polyacrylics, polyamines, polyvinylalcohols, polysaccharides, lactic acid, methacrylic acid, methacrylate, hydroxyethyl, ethylene glycol, ethylene oxide, acrylic acid, inorganic flocculants and inorganic coagulants.

### FIELD OF THE INVENTION

The present invention relates to a method to produce aggregates from unsettled cementitious mixtures. Particularly, the present invention relates to a method to prepare pellets with predicted particle size from fluid cementitious materials, to be used in diverse applications, including but not limited to substitution of aggregates in concrete mixtures for various functions. Furthermore, through this method one can produce aggregates with predicted particle size from any kind of unsettled cementitious mixtures, for example from mixtures with high fluidity, high binder content, low gravel to sand ratio and/or with high admixtures content.

### BACKGROUND OF THE INVENTION

On a daily basis, a significant amount of concrete produced at a ready-mix plant is not used. For example, contractors normally order an extra amount of concrete than the one needed for the job in hands, in order to account for unexpected setbacks, for example, shortage of concrete due to errors in calculations. When no setbacks occur, the superfluous concrete is returned to the plant, where it is recovered.

Another example of concrete that may be produced and not used is when, by mistake, a product is delivered to a customer with a different mix design than the one ordered, therefore having different properties than the ones requested by the client, for example, lower strength than the one required for the job or low workability retention.

Another example of concrete that may not be used and therefore is returned to the plant is when, due to a poor mix design, during the handling, transporting and placing, the cement paste and fine aggregates are separated from the coarse aggregates. This is called concrete segregation. If it happens during transportation, the concrete should be properly remixed before being used. Nevertheless, if setting time has already started, then it should not be used and is returned.

If the returned concrete has not settled yet, the drum of the ready-mix truck is washed, the excessive material removed and used in concrete production. In case the returned concrete has already hardened, it is crushed and reused as aggregate or landfilled.

In any case, returned concrete represents a loss to the concrete manufacturer, since it is product that has been fabricated and cannot be sold. Companies do their best to avoid returned product, for example by implementing GPS systems in trucks which are connected to a central station, so that concrete can be immediately redirected once an order changes. Nevertheless, said method is not foolproof and new solutions are being studied to deal with the issue.

One solution for the returned concrete is its conversion into aggregates.

Japanese Unity Model 3147832 refers to the usage of a polymer which is encapsulated inside a water soluble bag. When in contact with the fluid concrete, the paper bag dissolves and the polymer disperses inside the mix. After around 3 minutes under constant mixing, the polymer absorbs some of the returned concrete water and expands, incorporating the fines that exist in the mix, forming a kind of gel structure. This structure then covers the coarser aggregates, forming a granular material that can be used as roadbed material.

The method disclosed in the JP 3147832 U does not have the paper bag as optional. The present method does not need a paper water soluble bag, making it easier to be industrially applied. Also, JP 3147832 U does not disclose a method to predict the properties of the granular material obtained, namely the particle size, Los Angeles of the particles produced or the time to produce the pellets, like the present method does.

EP 2468695 also describes a method to recycle fresh unset concrete, forming granular materials through the addition of two components: a flash setting accelerator and a super-absorbent polymer. The polymer acts in a similar way to what is described in JP 3147832 U. The flash setting accelerator is said to reduce the porosity of the final granular materials, reducing the water absorption and consequently improving the mechanical properties of the final materials. Because of this, EP 2468695 claims that the granular materials obtained through their method may be used as aggregates in the construction industry.

The present invention avoids using a flash setting accelerator while using a higher dosage of super-absorbent polymer than EP 2468695. This allows achieving granular materials with good mechanical properties, as seen in the examples, that may be used as coarse aggregates in new fresh concrete mixes. The avoidance of flash setting accelerator and usage of only one component makes the present invention easier and more cost effective to be adopted by the industry. In addition, EP 2468695 shows no direction on how to predict the properties of the granular material obtained.

In conclusion, the prior art has not so far disclosed a method to produce aggregates with predictable size and tailored to diverse applications in the construction industry sector.

The problem to be solved is providing a method to reuse returned cementitious mixtures that would normally be disposed of, to produce materials that can be used as coarse aggregates in fresh concrete mixtures.

### DESCRIPTION OF THE INVENTION

The present invention provides a method to produce aggregates, comprising the steps of:

(a) adding at least one pelletizing agent to an unsettled cementitious mixture,
(b) mixing constantly the mixture of step (a) in a mixer to produce pellets,
(c) discharging the pellets obtained in step (b) and
(d) drying the pellets formed in step (c),
herewith method of the invention.

Another embodiments is the method of the invention, wherein said method is to produce coarse aggregates and wherein the method comprises the steps of:

(a) adding at least one pelletizing agent to an unsettled cementitious mixture,
(b) mixing constantly the mixture of step (a) in a mixer to produce pellets,
(c) discharging the pellets obtained in step (b) to form a pile,
(d) drying the pellets formed in step (c) for a curing time of minimum t1 to maximum t2 depending on the curing temperature according to the following equations:

t1=A×e^{-0.047×T(° C.)}

t2=B×e^{-0.04×T(° C.)}

wherein A is a parameter from 50 to 55, B is a parameter from 75 to 80 and T(° C.) represents the curing temperature in Celsius degrees and
(e) transforming the pile into a bed of dried pellets.

Another embodiment is the method of the invention, wherein the solid active content of the pelletizing agent is at a concentration in the range of 0.2 to 10 kg/m³ with respect to the unsettled cementitious mixture, preferably in the range of 0.8 to 10 kg/m³ and more preferably in the range of 0.8 to 3 kg/m³.

Another embodiment is the method of the invention, wherein the pelletizing agent in step (a) is selected from the group consisting of cellulose, chitosan, collagen, polyacrylamide and co-polymers of polyacrylamide and polyacrylics, polyamines, polyvinylalcohols, polysaccharides, lactic acid, methacrylic acid, methacrylate, hydroxyethyl, ethylene glycol, ethylene oxide, acrylic acid, inorganic flocculants and inorganic coagulants.

Another embodiment is the method of the invention, wherein the pelletizing agent is acrylamide-based, preferably a copolymer of acrylate and acrylamide monomers. This component brings the advantages of being effective, easily available in the market and non expensive.

Another embodiment is the method of the invention, wherein the water-to-cement ratio of said unsettled cementitious mixture is between 0.15 and 1.5.

The unsettled cementitious mixture may be, for example, mortar or concrete. Preferably, said cementitious mixture has a consistency selected from the group consisting of S0, S1, S2, S3, S4 and S5, more preferably a consistency selected from the group of S2, S3, S4 or S5, since the method has shown to be effective with highly fluid cementitious mixtures.

Also Self-Compacted Concrete (SCC) may be used as unsettled cementitious mixtures, with consistencies ranging from SF1 to SF3.

The consistencies indicated above are slump test's consistencies, according to tables 3 and 6 of the European Standard EN 206-2013.

The slump test of a concrete or mortar is carried out using a 300 mm high hollow steel cone with handles, a steel tamping rod, a steel base plate and a tape measure. The cone is positioned on the base plate with the smaller opening on top. Fresh concrete (or mortar) is poured into the cone to approximately one quarter of its depth (75 mm). When the concrete (or mortar) is too fluid, it will spread immediately over the base plate, even when the cone is still in position. In this case, the slump test is carried out with the smaller opening on the bottom (inverted cone).

The layer of concrete (or mortar) is compacted 25 times. After, further concrete (or mortar) is added to fill the cone to approximately one half of its depth and again, it is compacted with 25 strokes. Finally, the cone is filled to the top and compacted again, using the same procedure. The cone is then carefully lifted up and placed upside down next to the concrete stack, which will settle, or “slump” slightly. The difference in level between the top of the cone and the top of the concrete is measured, giving the slump.

The different consistencies possible are summarized in Table 1 and 2, respectively for concrete and Self-Compacted Concrete.

TABLE 1
Consistency of the concrete (Slump)

| | |
|---|---|
| EN 206-1 | NF P 18-305 |

| Class | slump [mm] | Consistency | slump [mm] |
|---|---|---|---|
| S1 | 10 to 40 | Stiff | 0 to 40 |
| S2 | 40 to 90 | Plastic | 50 to 90 |
| S3 | 100 to 150 | highly plastic | 100 to 150 |
| S4 | 160 to 210 | fluid | >160 |
| S5 | >220 | | |

TABLE 2
Slump-flow classes for SCC

| | Slump-flow tested in accordance |
|---|---|
| Class | with EN 12350-88 mm |
| SF1 | 550 to 650 |
| SF2 | 660 to 750 |
| SF3 | 760 to 850 |

The consistency of the initial cementitious mixture in step (a) may be modified to facilitate the dispersion of the pelletizing agent. For example, when the cementitious mixture to be pelletized has a S0 consistency, water may be added to have it more fluid prior to the pelletization, changing its consistency to a S2 or higher.

Preferably, the slump of the initial cementitious mixture in step (a) is from S2 to SF3.

In step (b) of the method of the invention, the mixing is carried out preferably at a rotation speed of 12-15 rpm and between 1 and 25 minutes, or until the totality of the initial finely divided material is agglomerated in the form of concrete pellets of spherical shape. This time can be extended by optimizing the amount of pelletizing agent added according to the type of concrete used—for example, a concrete with higher fluidity will need a higher amount of pelletizing agent to extend the period at which all the cementitious mixture is pelletized. Any mixer can be used to blend the ingredients, for example disc pelletizers, paddle mixers, drum pelletizers, pin mixer agglomerators, ribbon blenders, single paddle mixers, planetary mixer or even a pug mill or the rotary drum of a traditional concrete truck.

Reducing the mixing time within the mixing duration of 1-25 minutes has the advantage to reduce energy consumption of the mixer while increasing the minimum duration from 1 minute to 4 minutes reduces the risk of having non pelletized material. Therefore, more preferably the mixing time will be selected to be between 4 and 15 minutes.

Thus, in step (b) of the method of the invention, mixing is preferably carried out for 4 to 15 minutes and more preferably for 5 to 15 minutes.

The pellets obtained by the method of the invention are poured out of the mixer in step (c) forming a pile and allowed to dry for a time t. This drying time t is also called hardening time or curing time. The drying time t has a minimum value of t₁ that is dependent on the curing temperature and a maximum duration t₂ which is also dependent on the curing temperature—see FIG. 3.

The pellets may be air dried or using an oven, at any humidity and at a temperature not superior to 100° C., preferably the pellets should be dried at a temperature between −10° C. and 100° C. Naturally, the length of the drying step has to be adjusted according to the temperature at which the pellets are being dried (see Example 1). Pellets can be exposed to precipitation, as long as they are left to dry after. The pellets can also be cured by spraying or sprinkling water, to avoid sudden water loss and cracking. This prevents the pellets moisture from evaporating, contributing to the strength gain of the final pellet, improving their properties to be used as aggregates.

During the curing time t the pellets cannot be manipulated before duration t1 is achieved because they will disagglomerate due to lack of cohesion of the particles inside the pellets. Also the pellets cannot be manipulated after the duration t2 since they will stick together due to high cohesion between the pellets and their use as discrete aggregates can no longer be effective, unless an additional mechanical operation to break the bonds between aggregates is used, which is highly inefficient in terms of industrialization. By “manipulate” we mean manually or mechanically move the pellets or the granulated material produced in order to store or dispose them in another location.

According to a preferred embodiment the pile of pellets is transformed into a horizontal bed of pellets by pulling the material from the file, for instance using the bucket of a loader, to spread the pellets on the ground. This manipulating action has to take place between the duration t1 and t2 (see FIG. 3) and will destroy by shear the bridges that are forming between individual pellets, avoiding that the pellets start to stick together.

Preferably, the height of the bed of cured pellets is selected to be lower than 15 cm in order to minimize the transportation time and cost, while ensuring that forming bonds between pellets is destroyed.

Once the pile of pellets has been transformed into a bed of pellets, manually or mechanically, the pellets can be stored as aggregates or directly used in fresh concrete production.

The method of the invention is effective for any type of cementitious mixture, including returned concrete or mortar or any type of concrete or mortar that, for any reason, cannot be used but is still fluid and has not yet completely settled. Examples of concrete that cannot be placed and therefore can be used in this invention are superfluous concrete that has not been used at the job site, mortars or concretes that have a wrong mix design and therefore are not used or concrete or mortars that have lost their properties due to a poor mix design (example, segregation).

The present invention is suitable for any kind of cementitious mixtures, even cementitious mixtures with high fluidity, high binder content, low gravel to sand ratio and/or with high admixtures content. It also works in segregated concrete, a common reason for concrete return.

Typically, 1 m³ of fresh cementitious mixture described in step (a) of the method of the invention comprises 50-1000 kg of a cementitious binder, said cementitious binder comprises between 40% to 100% of Ordinary Portland Cement (OPC), more preferably between 50% and 100% of OPC, and supplementary cementitious materials, including but not limited to slag, fly ash, silica fume and natural pozzolans. Furthermore, the fresh cementitious mixture described in step (a) is also comprised of aggregates, whereas said aggregates comprise 30-95% (% volume) of fine aggregates and 5-70% (% volume) of coarse aggregates. Furthermore, the fresh cementitious mixture described in step (a) may also have superplasticizer (e.g. based on melamine, naphthalene, lignosulfonate or polycarboxylates) in a range between 0% to 3% (w/w of cementitious material weight) and also 0-2% (w/w of cementitious material weight) of a retarder (e.g., lignin, borax, sugars or tartaric acids and salts). Also a stabilizing agent may be used, (normally a polysaccharide, carboxylic acids or phosphorus-containing organic acid salts), in a concentration ranging between 0-2% (w/w of cementitious material weight). The water-to-cement ratio of said cementitious mixture described in step (a) is between 0.15 and 1.5. In some cases, the fresh cementitious mixture described in step (a) may also have 0 to 5% (w/w of cementitious material weight) of self-curing agent and/or 0 to 5% (w/w of cementitious material weight) of an air-entraining agent. Also deformers may be present in the cementitious mixture, from 0 to 0.5% (w/w of cementitious material weight). Said cementitious mixture may also have an accelerator, from 0 to 25% (w/w of cementitious material weight). The presence of other mineral additives and/or fibers is also possible, since this embodiment will improve the dispersion and bonding of the fibers to the matrix. Pigments may also be present in the original mix, since they will not affect the formation of the pelletized material.

All percentages above are active solid contents.

The final aggregates produced by this method have good mechanical properties, good resistance against abrasion and fragmentation, which is guaranteed by the Los Angeles values obtained for the aggregates produced, which never surpass the value 50.

The Los Angeles (L.A.) abrasion test is a method to assess how hard an aggregate is and its abrasion properties. These are important because the aggregates must resist crushing, degradation and disintegration to ensure the endurance of the future pavement. The L.A. value is determined according to AASHTO T 96 or ASTM C 131 and should be below 60.

According to the method of the invention, the aggregates formed by the method of the invention have a Los Angeles value (according to AASHTO T 96 or ASTM C 131) between 15 and 50.

The pellets obtained by the method of the invention may be used as aggregates in fresh concrete mixes, namely they can be used to partially substitute coarse aggregates in fresh concrete mixes, specifically 4/16 mm and 8/16 mm aggregates, by targeting a specific particle size distribution, monodispersed, of the pellets produced, as it will be further described. Targeting one specific range of aggregates produced according to the method of the invention brings several advantages to the operations that will use these pellets as coarse aggregates, namely it is easier for the operations to adapt the mix designs because only one range of the aggregates is produced and therefore, substituted. If one has no control in the pellets produced, as happens with the methods described in the prior art, it is more difficult for the operations to know how to build the mix designs, since operations don't know which kind of aggregates will be produced, in which ranges and in which amounts. Furthermore, the pellets produced according to other methods, having a random particle size distribution, will need to be first separated according to sizes, which is not attractive to the ready-mix operations, that will end up discarding the method of recycling unsettled concrete mixes and use normal coarse aggregates.

The decision of totally or partially substitute the aggregates in fresh concrete mixes should be taken by the constructor. The properties of this final concrete are similar to the properties of fresh concrete with the same mix design where all coarse aggregates are the traditional ones normally used in a typical mix design. Therefore, the properties of the final concrete may be tailored to a specific use in the same way as a traditional concrete would be, for example for structural applications.

Another embodiment is the method of the invention, wherein the aggregates obtained by the method of the invention are used in decorative architectonic constructions. Pigments can be added to the mix in step (a) of the method to fulfill this purpose; said pigments can be organic or inorganic and may be added in a concentration between 0-100 kg/m³ of mix, depending on the intensity of the color desired for the pellets produced.

It was observed that the substitution of coarse aggregates by pelletized cementitious mixture in a concrete mix does not have a negative effect in the compressive strength at 1, 7 and 28 days, nor in the density at 1, 7 and 28 days. This is shown in Example 1.

After step (e), a Particle Size Distribution is done to the pellets and three sieve passings are analyzed: 1) D₁₀, which is the sieve size [mm] at which the passing is 10%; 2) D₉₀, which is the sieve size [mm] at which the passing is 90% and 3) D₅₀, which is the sieve size [mm] at which the passing is 50%. D₉₀/D₁₀ can then be calculated, which is a monogranular index.

According to the embodiment of the invention, D₉₀/D₁₀ is targeted to be between 2 and 10. This ensures that the produced pellets are monogranular and can be used to substitute one fraction of coarse aggregates, which is defined by D₅₀ as will be explained.

D₉₀/D₁₀ can be controlled through both mixing time and pelletizing agent dosage.

FIG. 1 shows the relation between pelletizing agent added in step (a) and D₉₀/D₁₀.

FIG. 2 shows the relation between mixing time in step (b) and D₉₀/D₁₀.

Therefore, one can adjust these parameters in order to achieve a D₉₀/D₁₀ ratio between 2-10 which indicates a monogranular index.

When a D₉₀/D₁₀ between 2 and 10 is achieved, one is sure that the aggregates produced correspond to only one fraction and with this assurance, D₅₀ can be measured. D₅₀ is the sieve size [mm] at which the passing is 50%, so D₅₀ tells us the main size of the fraction produced and which fraction may be replaced. More concretely:

If 4<D₅₀<8, 4/8 mm aggregates are to be substituted;

If 8<D₅₀<11, 8/11 mm aggregates are to be substituted;

If 11<D₅₀<16, 11/16 mm aggregates are to be substituted;

If D₅₀ falls between an intermediary value (4, 8, 11 or 16), then it is up to the executor of the invention to choose which fraction to substitute, either the lower or the upper fraction. For example, if D₅₀ is equal to 4, then either the fraction 0/4 mm or 4/8 mm can be substituted.

It has also been observed that the pelletization time, meaning the time at which all the initial cementitious mixture in step (a) is pelletized, can be delayed by adding more pelletizing agent in step (a). Therefore, the pelletization time can be delayed if needed, for example if a problem occurs with the equipment and the method has already been started but has to be delayed for some minutes.

It has also been observed that the hardness of the pellets obtained in step (b) can be improved by increasing the dosage of the pelletizing agent.

### List of Definitions

Hydraulic binder. It is a material with cementing properties that sets and hardens due to hydration even under water. Hydraulic binders produce calcium silicate hydrates also known as CSH.

Cement. It is a binder that sets and hardens and brings materials together. The most common cement is the ordinary Portland cement (OPC) and a series of Portland cements blended with other cementitious materials.

Ordinary Portland cement. Hydraulic cement made from grinding clinker with gypsum. Portland cement contains calcium silicate, calcium aluminate and calcium ferroaluminate phases. These mineral phases react with water to produce strength.

Hydration. It is the mechanism through which OPC or other inorganic materials react with water to develop strength. Calcium silicate hydrates are formed and other species like ettringite, monosulfate, Portlandite, etc.

Mineral Addition. Mineral admixture (including the following powders: silica fume, fly ash, slags) added to concrete to enhance fresh properties, compressive strength development and improve durability.

Silica fume. Source of amorphous silicon obtained as a byproduct of the silicon and ferrosilicon alloy production. Also known as microsilica.

Fibers. Material used to increase concrete's structural performance. Fibers include: steel fibers, glass fibers, synthetic fibers and natural fibers.

Alumino silicate-by-product (Fly Ash—bottom ash). Alkali reactive binder components that together with the activator form the cementitious paste. These minerals are rich in alumina and silica in both, amorphous and crystalline structure.

Natural Pozzolan. Aluminosilicate material of volcanic origin that reacts with calcium hydroxide to produce calcium silicate hydrates or CSH as known in Portland cement hydration.

Filler inert. Material that does alter physical properties of concrete but does not take place in hydration reaction.

Admixture. Chemical species used to modify or improve concrete's properties in fresh and hardened state. These could be air entrainers, water reducers, set retarders, superplasticizers and others.

Silicate. Generic name for a series of compounds with formula Na₂O.nSiO₂. Fluid reagent used as alkaline liquid when mixed with sodium hydroxide. Usually sodium silicate but can also comprise potassium and lithium silicates. The powder version of this reagent is known as metasilicates and could be pentahydrates or nonahydrates. Silicates are referred as Activator 2 in examples in this application.

Initial dispersant. It is a chemical admixture used in hydraulic cement compositions such as Portland cement concrete, part of the plasticizer and superplasticizer family, which allow a good dispersion of cement particles during the initial hydration stage.

Superplasticizers. It relates to a class of chemical admixture used in hydraulic cement compositions such as Portland cement concrete having the ability to highly reduce the water demand while maintaining a good dispersion of cement particles. In particular, superplasticizers avoid particle aggregation and improve the rheological properties and workability of cement and concrete at the different stage of the hydration reaction.

Coarse Aggregates. Manufactured, natural or recycled minerals with a particle size greater than 8 mm and a maximum size lower than 32 mm.

Fine Aggregates. Manufactured, natural or recycled minerals with a particle size greater than 4 mm and a maximum size lower than 8 mm.

Sand. Manufactured, natural or recycled minerals with a particle size lower than 4 mm.

Concrete Ingredients. Concrete is primarily a combination of hydraulic binder, sand, fine and/or coarse aggregates, water. Admixture can also be added to provide specific properties such as flow, lower water content, acceleration, etc.

Workability. The workability of a material is measured with a slump test (see below).

Workability retention. It is the capability of a mix to maintain its workability during the time. The total time required depends on the application and the transportation.

Pellets. Small, rounded, compressed mass of substance, in the case of the present invention, of returned concrete.

Agglomerate. To gather into a ball, mass, or cluster, in the case of the present invention, to gather into pellets.

Strength development—setting/hardening. The setting time starts when the construction material changes from plastic to rigid. In the rigid stage the material cannot be poured or moved anymore. After this phase the strength development corresponding to the hardening of the material.

Consistency of the concrete. Consistency reflects the rheological properties of fresh concrete by means of slump as defined in Table 1.

### BRIEF DESCRIPTION OF THE FIGURES

FIG. 1. Relation between pelletizing agent added in step (a) and D₉₀/D₁₀.

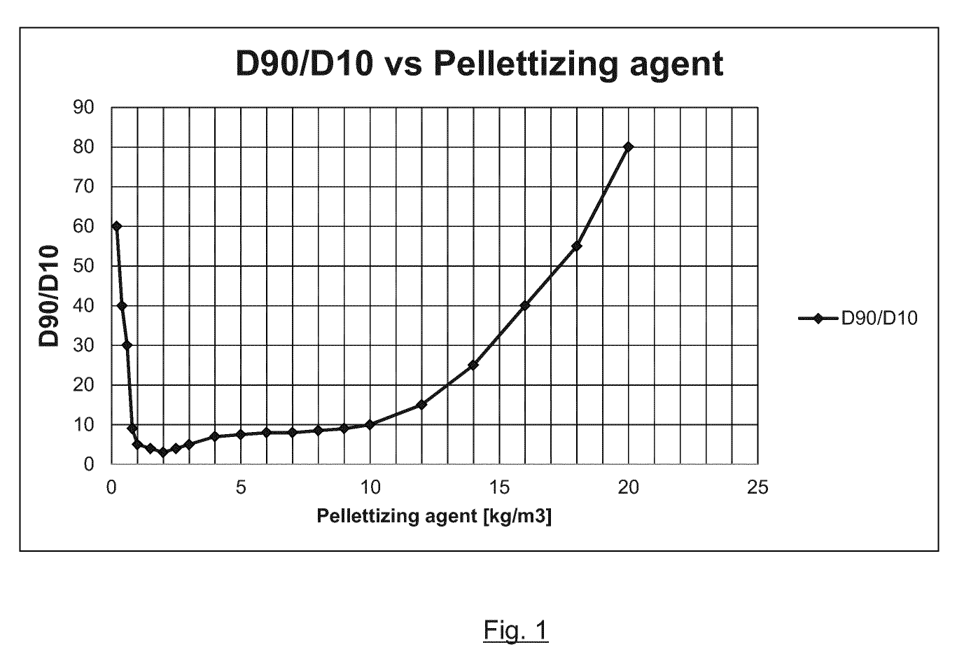

FIG. 2. Relation between mixing time in step (b) and D₉₀/D₁₀.

FIG. 3. Pellets' curing time versus curing temperature (° C.).

FIG. 4. PSD of obtained pellets in Example 6.

### EXAMPLES OF THE INVENTION

### Example 1

To test the characteristics of concrete where part of its aggregates is substituted by the pelletized material, lab tests were performed. First, a returned concrete was simulated having the following mix design:

TABLE 3
Mix Design of the returned concrete

| MATERIAL | UNIT | MIX 1 |
|---|---|---|
| CEM I 52.5 R | kg/m3 | 330 |
| Fly ash | kg/m3 | 0 |
| Limestone filler | kg/m3 | 0 |
| w/b total | — | 0.71 |
| w/b eff | — | 0.6 |
| Sand 0/4 round | kg/m3 | 807 |
| Gravel 4/8 crushed | kg/m3 | 359 |
| Gravel 8/11 crushed | kg/m3 | 609 |
| Superplasticizer | % mass of cem | 1% |
| Retarder | % mass of cem | 0.20% |
| Pelletizing agent | kg/m3 | 2.1 |

Slump flow at 5 minutes was 680 mm (SF2).

All the components, except the pelletizing agent, were mixed for a couple of minutes. The pelletizing agent was then added. The mixes were then stirred for 5 minutes, after which the materials were completely pelletized.

Pellets were discharged into a pile and left to dry at a temperature of 17° C. for 29 hours.

Table 4 summarizes the characteristics of the pellets obtained:

TABLE 4
Properties of the recycled aggregates produced

| | UNIT | MIX 1 |
|---|---|---|
| D₁₀ pellets | mm | 1.018 |
| D₉₀ pellets | mm | 4.55 |
| D₉₀/D₁₀ pellets | — | 4.47 |
| D₅₀ | mm | 4.78 |
| Los Angeles | — | 33 |

The pellets could be used to substitute 4/8 mm coarse aggregates in fresh concrete.

### Example 2

A concrete with the mix design described in Table 5 was sent to a job site but was partially returned to the plant.

TABLE 5
Mix design of the returned concrete
Concrete mix design

| | | |
|---|---|---|
| CEM I 52.5 N | [kg/m3] | 350 |
| w/c | [—] | 0.57 |
| 0/4 round | [% agg volume] | 42% |
| 4/8 round | [% agg volume] | 26% |
| 8/12 round | [% agg volume] | 32% |
| Plasticizer | [% mass cement] | 1.70% |
| Retarder | [% mass cement] | 0.35% |
| Slump | [cm] | 17.5 |
| Workability class | [—] | S4 |

At the plant, 1.35 kg/m³ of pelletizing agent was added to the concrete inside the truck and mixed during 6 minutes, at a rotation speed of 14 rpm.

After these 6 minutes, the material was completely agglomerated into pellets. They were discharged from the mixer forming a pile and were left to curing. Since the external temperature was 22° C., the pile was left to dry during 24 hours.

The recycled aggregates produced had the following characteristics:

TABLE 6
Recycled aggregates characteristics

D₁₀ = 2.8 mm
D₅₀ = 8.3 mm
D₉₀ = 15.8 mm
D₉₀/D₁₀ = 5.64
L.A. = 38

According to Table 6, monogranular aggregates were produced that could substitute the fraction 8/11 mm of coarse aggregates in fresh concrete.

### Example 3

A concrete mix design with the following characteristics was produced:

TABLE 7
Mix design
Concrete mix design

| | | |
|---|---|---|
| CEM III 42.5 R | [kg/m3] | 325 |
| Fly ash | [kg/m3] | 75 |
| w/binder | [—] | 0.47 |
| 0/2 round | [% agg volume] | 32% |
| 2/10 crusehd | [% agg volume] | 41% |
| 10/16 crushed | [% agg volume] | 27% |
| Superplasticizer | [% mass binder] | 2.14% |
| Defoaming agent | [% mass binder] | 0.05% |

Table 8 summarizes the fresh properties of this concrete:

TABLE 8
Fresh Properties
Fresh properties

| | | |
|---|---|---|
| Slump flow | [cm] | 71.5 |
| Workability class | [—] | SF2 |

Part of this concrete was returned to the plant. 2.9 kg/m³ of pelletizing agent was added to the concrete truck's mixing drum and mixing was done for 4.5 minutes at a rotation speed of 16 rpm. The pellets were discharged into a pile and left to dry at a temperature of 25° C. for 16 hours.

The Particle Size Distribution of these pellets was done and summarized in table 8:

TABLE 9
Particle Size Distribution of the produced pellets
Particle Size Distribution

| Sieve | Passing |
|---|---|
| [mm] | [%] |
| 63 | 100.00% |
| 31.6 | 100.00% |
| 20 | 91.57% |
| 16 | 87.63% |
| 14 | 85.37% |
| 12.5 | 75.40% |
| 10 | 67.64% |
| 8 | 44.77% |
| 6.3 | 30.49% |
| 4 | 13.55% |
| 2 | 8.94% |
| 1 | 6.74% |
| 0.5 | 4.43% |
| 0.25 | 1.33% |
| 0.125 | 0.07% |
| 0.063 | 0.00% |

The pellets produced had the following characteristics:

TABLE 10
Properties of the produced pellets
Aggregates characterization

| | | |
|---|---|---|
| D10 | [mm] | 2.460 |
| D50 | [mm] | 8.457 |
| D90 | [mm] | 18.406 |
| D90/D10 | [—] | 7.48 |
| L.A. | [—] | 24 |

### Example 4

A returned concrete had the following mix design:

TABLE 11
Mix Design of the returned concrete
MIX DESIGN OF THE RETURNED CONCRETE

| | Unit | Mix Design |
|---|---|---|
| CEM I 52.5 | kg/m3 | 450 |
| w/b | — | 0.45 |
| Superplasticizer | % on cem | 0.90% |
| Stabilizer | % on cem | 0.50% |
| Aggregate 0/4 round | % Volume | 50% |
| Aggregate 4/8 round | % Volume | 30% |
| Aggregate 8/16 round | % Volume | 20% |

Slump flow at 5 minutes was 680 mm (SF2).

1.1 kg/m³ of a pelletizing agent were added to this mix under mixing. After 5 minutes, the initial cementitious material was completely pelletized.

Pellets were put into a pile and left to dry at a temperature of 11° C. for 39 hours.

Table 12 summarizes the properties of the aggregates produced.

TABLE 12
Properties of the obtained pellets

D₁₀ = 4.20 mm
D₅₀ = 9.12 mm
D₉₀ = 16.04 mm
D₉₀/D₁₀ = 3.82
L.A. = 41

The pellets obtained could be used to substitute the fraction 8/11 mm of coarse aggregates.

### Example 5

To test the properties of a concrete where part of its coarse aggregates are substituted with the pellets obtained previously in example 4, three mix designs were done where the only difference between them was the amount of coarse aggregates substituted by the pelletized returned unsettled concrete. In a first mix design, no pellets were added; in a second mix design, 5% of the coarse aggregates were substituted by the pellets and in a third mix design, 10% of the coarse aggregates were substituted by the pelletized returned unsettled concrete:

TABLE 13
Mix design for the three fresh concretes produced

| | | 0% - | 5% | 10% |
|---|---|---|---|---|
| | Unit | Reference | Substitution | Substitution |
| CEM I 52.5 | kg/m3 | 350 | 350 | 350 |
| w/b | — | 0.55 | 0.55 | 0.55 |
| Superplasticizer | % on cem | 0.30% | 0.30% | 0.30% |
| Aggregate 0/4 | % volume | 45% | 45% | 45% |
| round | | | | |
| Aggregate 4/8 | % volume | 20% | 20% | 20% |
| crushed | | | | |
| Aggregate 8/11 | % volume | 35% | 30% | 25% |
| crushed | | | | |
| Pelletized Recycled | % volume | — | 5% | 10% |
| Concrete | | | | |

The slump, as well as the compressive strength and densities obtained after 1, 7 and 28 days can be found in Tables 14, 15 and 16, respectively.

TABLE 14
Workability Retention - Slump
SLUMP

| | | 0% | 5% | 10% |
|---|---|---|---|---|
| Time [min] | Unit | Reference | Substitution | Substitution |
| 5 | cm | 11.0 | 9.0 | 7.5 |
| 30 | cm | 9.0 | 8.5 | 7.5 |
| 60 | cm | 7.5 | 7.5 | 7.0 |
| 90 | cm | 6.5 | 6.0 | 6.0 |

TABLE 15
Compressive Strengths obtained
COMPRESSIVE STRENGTH

| | | 0% | | |
|---|---|---|---|---|
| Time [Days] | Unit | Reference | 5% Substitution | 10% Substitution |
| 1 | MPa | 21.3 | 24 | 22.2 |
| 7 | MPa | 41.6 | 42.9 | 39.6 |
| 28 | MPa | 44.5 | 45.4 | 43.5 |

TABLE 16
Densities obtained
DENSITY

| | | 0% | | |
|---|---|---|---|---|
| Time [Days] | Unit | Reference | 5% Substitution | 10% Substitution |
| 1 | kg/m3 | 2313.7 | 2325.3 | 2291.3 |
| 7 | kg/m3 | 2323.3 | 2263.5 | 2259.9 |
| 28 | kg/m3 | 2279.0 | 2288.4 | 2297.4 |

As one can see from Table 14, the slump is not affected by the partial substitution of the aggregates. Also, from Tables 15 and 16, the hardened properties of the concretes where part of the coarse aggregates were substituted by pelletized returned concrete are similar to the ones obtained for the reference concrete. In fact, an improvement in strength was actually obtained when 5% of the coarse aggregates were substituted by the pelletized returned unsettled concrete.

This example shows that neither the compressive strength nor the densities are dramatically affected by the partially substitution of coarse aggregates by pelletized returned unsettled concrete.

### Example 6

Two concretes with the properties displayed in Table 17 were produced at one plant to be sent to the customers that have requested them:

TABLE 17
Mix design
MIX DESIGN

| | | | | | Sand | Gravel | |
|---|---|---|---|---|---|---|---|
| | Binder | | | Super- | 0/4 | 4/8 | 8/11 |
| Type of | CEM I 52.5 R | Water | | plasticizer | round | crushed | crushed |
| Concrete | [kg/m³] | W/B_{eq} | W/Bₜₒₜ | [%] | vol [%] | vol [%] | vol [%] |
| HPSCC* | 600 | 0.30 | 0.31 | 1.50 | 45.00 | 20.00 | 35.00 |
| Conventional | 300 | 0.65 | 0.70 | — | 45.00 | 20.00 | 35.00 |
| Concrete | | | | | | | |

*HPSCC: High Performance Self-Compacting Concrete
W/B_{eq}: Water-Binder ratio
W/Bₜₒₜ: Water-Binder ratio total

Table 18 shows the fresh properties of both concretes:

TABLE 18
Fresh Properties

| | FRESH PROPERTIES | | |
|---|---|---|---|
| MIX DESIGN | SLUMP | SLUMP FLOW | air content |
| Type of Concrete | [cm] | [cm] | [%] |
| HPSCC | — | 68.00 | 1.00 |
| Conventional Concrete | 17 | — | 4.10 |

A part of both concretes was returned to the plant. 2.0 kg/m³ of Pelletizing agent was added to both concretes at the plant and aggregates were produced. Table 19 shows the properties of the hardened concrete.

TABLE 19
Hardened Properties

| | HARDENED | | |
|---|---|---|---|
| | PROPERTIES | | |
| | Compressive | | |
| | strenght vs time | | |
| MIX DESIGN | [MPa] vs [day] | | |
| Type of Concrete | 1 | 7 | 28 |
| HPSCC | 54.87 | 71.82 | 83.95 |
| Conventional Concrete | 10.86 | 27.60 | 31.31 |

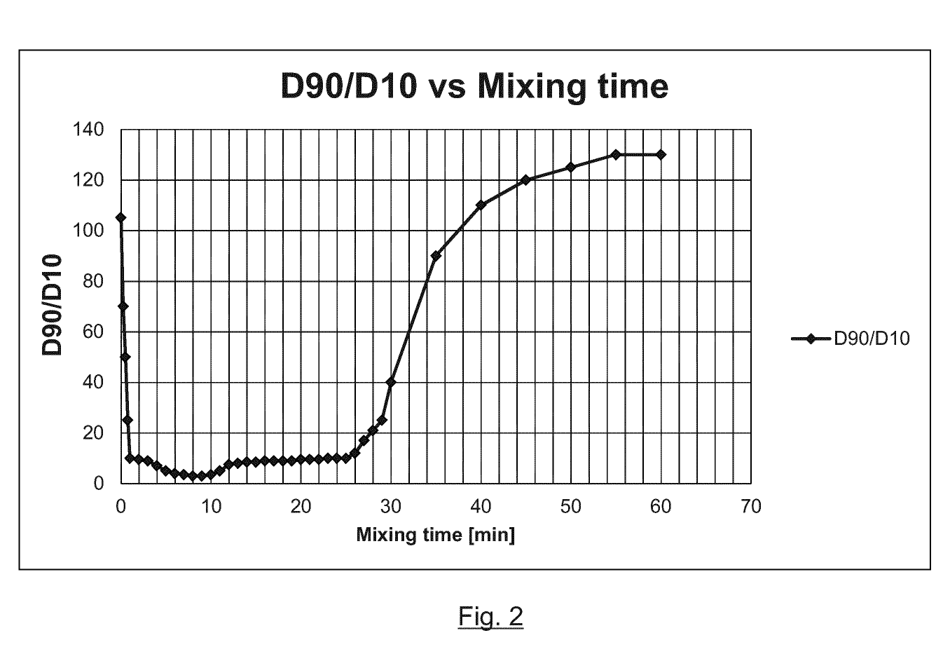

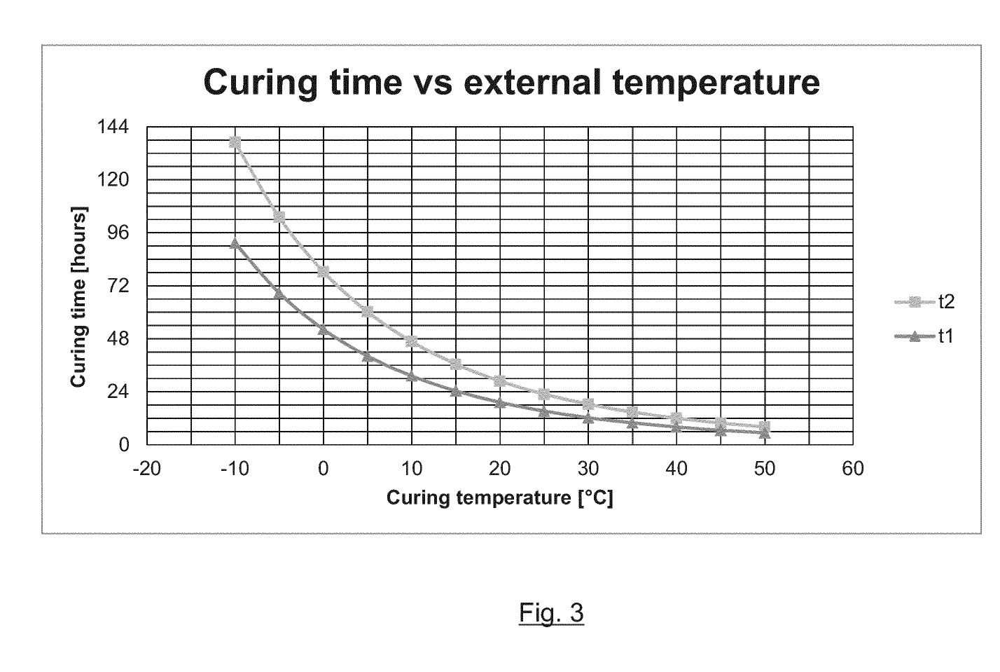

FIG. 2 shows the Particle Size Distribution of the pellets obtained. The PSD was adjusted to that D₉₀/D₁₀ falls between 2 and 10 to ensure a monogranular fraction of aggregates. Final PSD plot is shown in FIG. 3 and D₉₀, D₁₀ and D₅₀ values are shown in Table 15.

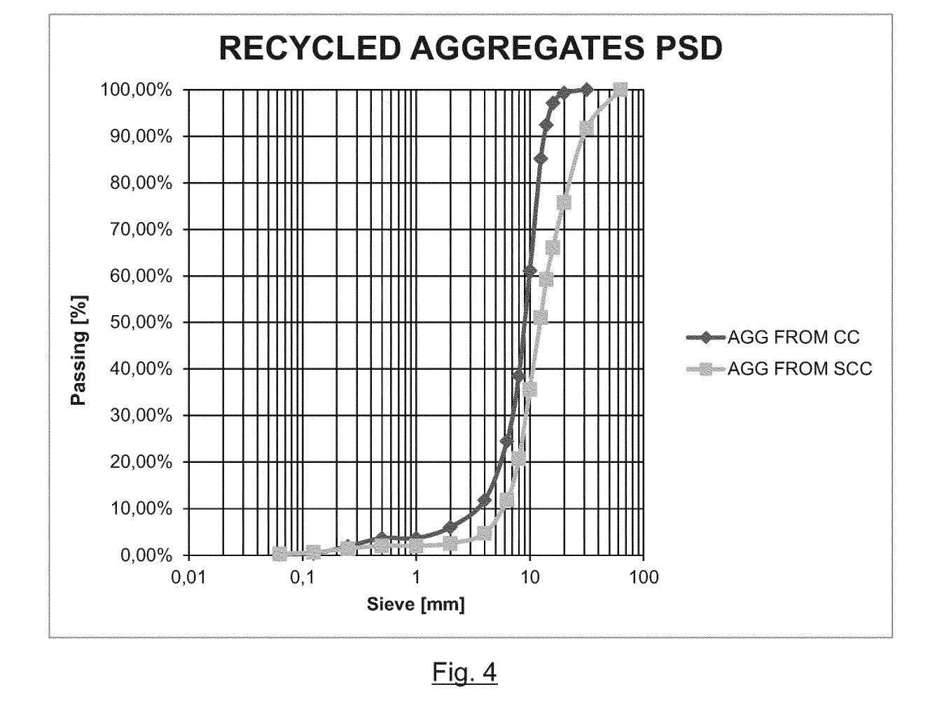

From FIG. 4, one derives the values shown in Table 20.

TABLE 20
PSD analysis for the recycled aggregates produced with
both concretes, SCC and Conventional Concrete.

| | D₉₀ | D₁₀ | D₉₀/D₁₀ | D₅₀ |
|---|---|---|---|---|
| HPSCC | 32 | 6.3 | 5 | 12.5 |
| Conventional Concrete | 14 | 4 | 3.5 | 10 |

From D₉₀/D₁₀, one can conclude that both recycled aggregates produced are monogranular. These aggregates produced may be used as substitutes of the 8/11 mm fraction in new concrete. Table 21 shows the Los Angeles values for both recycled aggregates:

TABLE 21
Los Angeles values for the recycled aggregates produced
with HPSCC and conventional concretes.

| | | Conventional Concrete |
|---|---|---|
| | HPSCC Aggregates | Aggregates |
| Los Angeles Values | 36 | 29 |

The recycled aggregates produced were used as substitution of the 8/11 mm fraction of coarse aggregates in new conventional concretes. 0%, 5%, 10% and 15% of the coarse aggregates in the mix designs were substituted with the recycled aggregates produced. The mix designs for this fresh concrete are in Table 22.

TABLE 22
Mix Designs for new fresh Concretes using 0%, 5%, 10% and 15% of recycled aggregates.
MIX DESIGN

| | Binder | | | | Admixtures | | Aggregates | | | | |
|---|---|---|---|---|---|---|---|---|---|---|---|
| | CEM I | Fly | | | Super- | Stabi- | 0/4 | 4/8 | 8/11 | RA from | RA from |
| | 52.5 R | ash | Water | | plasticizer | lizer | round | crushed | crushed | HPSCC | CC |
| | [kg/m³] | [kg/m³] | W/B_{eq} | W/Bₜₒₜ | [% binder] | [% binder] | vol [%] | vol [%] | vol [%] | vol [%] | vol [%] |
| REF 1 | 300 | — | 0.65 | 0.70 | 0.30 | 0.00 | 45.00 | 20.00 | 35.00 | 0.00 | — |
| MIX 1 | 300 | — | 0.65 | 0.70 | 0.30 | 0.00 | 45.00 | 20.00 | 30.00 | 5.00 | — |
| MIX 2 | 300 | — | 0.65 | 0.70 | 0.30 | 0.00 | 45.00 | 20.00 | 25.00 | 10.00 | — |
| MIX 3 | 300 | — | 0.65 | 0.70 | 0.30 | 0.00 | 45.00 | 20.00 | 20.00 | 15.00 | — |
| MIX 4 | 300 | — | 0.65 | 0.70 | 0.30 | 0.00 | 45.00 | 20.00 | 30.00 | — | 5.00 |
| MIX 5 | 300 | — | 0.65 | 0.70 | 0.30 | 0.00 | 45.00 | 20.00 | 25.00 | — | 10.00 |
| MIX 6 | 300 | — | 0.65 | 0.70 | 0.30 | 0.00 | 45.00 | 20.00 | 20.00 | — | 15.00 |
| REF 2 | 400 | 250 | 0.30 | 0.27 | 3.00 | 0.50 | 45.00 | 20.00 | 35.00 | 0.00 | — |
| MIX 7 | 400 | 250 | 0.30 | 0.27 | 3.00 | 0.50 | 45.00 | 20.00 | 30.00 | 5.00 | — |
| MIX 8 | 400 | 250 | 0.30 | 0.27 | 3.00 | 0.50 | 45.00 | 20.00 | 25.00 | 10.00 | — |
| MIX 9 | 400 | 250 | 0.30 | 0.27 | 3.00 | 0.50 | 45.00 | 20.00 | 20.00 | 15.00 | — |
| MIX 10 | 400 | 250 | 0.30 | 0.27 | 3.00 | 0.50 | 45.00 | 20.00 | 30.00 | — | 5.00 |
| MIX 11 | 400 | 250 | 0.30 | 0.27 | 3.00 | 0.50 | 45.00 | 20.00 | 25.00 | — | 10.00 |
| MIX 12 | 400 | 250 | 0.30 | 0.27 | 3.00 | 0.50 | 45.00 | 20.00 | 20.00 | — | 15.00 |

Table 23 shows the fresh properties of the concretes produced, while Table 15 shows the hardened properties of the concretes produced.

TABLE 23
Fresh Properties of the Concretes Produced

| | FRESH PROPERTIES | | | | | | | | |
|---|---|---|---|---|---|---|---|---|---|
| | | | | | | | | | air |
| | SLUMP [cm] vs time [min] | | | | SLUMP FLOW [cm] vs time [min] | | | | content |
| | 5 | 30 | 60 | 90 | 5 | 30 | 60 | 90 | [%] |
| REF 1 | 18.5 | 15.0 | 12.5 | 10.5 | — | — | — | — | 2.3% |
| MIX 1 | 21.5 | 20.5 | 19.0 | 14.5 | — | — | — | — | 1.9% |
| MIX 2 | 19.0 | 18.0 | 14.0 | 12.0 | — | — | — | — | 2.1% |
| MIX 3 | 18.0 | 16.5 | 13.5 | 11.0 | — | — | — | — | 2.4% |
| MIX 4 | 20.0 | 18.5 | 16.5 | 12.5 | — | — | — | — | 2.1% |
| MIX 5 | 18.5 | 16.0 | 13.5 | 11.0 | — | — | — | — | 2.4% |
| MIX 6 | 17.5 | 15.0 | 13.0 | 9.5 | — | — | — | — | 2.7% |
| REF 2 | — | — | — | — | 67 | 72 | 68 | 64 | 1.6% |
| MIX 7 | — | — | — | — | 71 | 74 | 71 | 70 | 1.2% |
| MIX 8 | — | — | — | — | 68 | 72 | 70 | 67 | 1.5% |
| MIX 9 | — | — | — | — | 65 | 69 | 69 | 65 | 1.6% |
| MIX 10 | — | — | — | — | 68 | 70 | 69 | 65 | 1.7% |
| MIX 11 | — | — | — | — | 65 | 67 | 64 | 63 | 1.8% |
| MIX 12 | — | — | — | — | 64 | 66 | 63 | 62 | 2.1% |

TABLE 24
Hardened Properties of the Concretes Produced

| | Compressive | | |
|---|---|---|---|
| | strength vs time | | |
| | [MPa] vs [day] | | |
| | 1 | 7 | 28 |
| REF 1 | 16.88 | 35.00 | 44.0 |
| MIX 1 | 12.58 | 31.06 | 36.5 |
| MIX 2 | 17.49 | 38.54 | 45.7 |
| MIX 3 | 14.48 | 35.60 | 40.5 |
| MIX 4 | 15.17 | 34.25 | 38.5 |
| MIX 5 | 19.35 | 38.73 | 44.2 |
| MIX 6 | 13.06 | 31.81 | 34.5 |
| REF 2 | 29.08 | 75.72 | 79.8 |
| MIX 7 | 29.44 | 71.14 | 86.5 |
| MIX 8 | 44.90 | 73.02 | 89.9 |
| MIX 9 | 18.05 | 66.47 | 72.7 |
| MIX 10 | 18.00 | 64.92 | 72.0 |
| MIX 11 | 23.76 | 67.86 | 77.8 |
| MIX 12 | 19.66 | 63.64 | 70.9 |

From Table 24, it is seen that the usage of recycled aggregates produced according to the method herein described did not impact negatively the compressive strength of the final concrete at 28 days, actually it could even improve it (for example, Mixes 7 and 8).

### Example 7

A concrete with the following mix design was produced:

TABLE 25
Concrete mix design
Concrete mix design

| | | |
|---|---|---|
| CEM II/A-LL 42.5 N | [kg/m3] | 280 |
| GGBS | [kg/m3] | 55 |
| w/binder | [—] | 0.61 |
| 0/4 crushed | [% agg volume] | 45% |
| 4/8 crushed | [% agg volume] | 25% |
| 8/16 round | [% agg volume] | 30% |
| PCE-base superplasticizer | [% mass binder] | 0.42% |
| Retarder | [% mass binder] | 0.20% |

Fresh properties

| | | |
|---|---|---|
| Slump | [cm] | 22 |
| Workability class | [—] | S5 |

This concrete was partially returned and was pelletized in order to produce aggregates:

TABLE 26
Pelletizing and curing processes
Pellettizing process

| | | |
|---|---|---|
| Pellettizing agent | [kg/m3] | 1.3 |
| Pellettizing time | [min] | 31 |
| Rotation speed | [1/min] | 12 |

Curing process

| | | |
|---|---|---|
| Curing time | [h] | 16 |
| Curing temperature | [° C.] | 25 |

Due to an error of the operator, the pelletization time was extended beyond 25 minutes. Tables 27 and 28 summarize the characteristics of the aggregates obtained.

TABLE 27
Particle Size Distribution of the pellets produced
Particle Size Distribution

| Sieve | Passing |
|---|---|
| [mm] | [%] |
| 63 | 100.00% |
| 31.6 | 89.63% |
| 20 | 86.45% |
| 16 | 82.47% |
| 14 | 78.92% |
| 12.5 | 67.89% |
| 10 | 54.87% |
| 8 | 41.56% |
| 6.3 | 27.95% |
| 4 | 13.55% |
| 2 | 8.94% |
| 1 | 5.41% |
| 0.5 | 3.98% |
| 0.25 | 1.87% |
| 0.125 | 1.20% |
| 0.063 | 0.00% |

TABLE 28
Aggregates characterization
Aggregates characterization

| | | |
|---|---|---|
| D₁₀ | [mm] | 2.460 |
| D₅₀ | [mm] | 9.268 |
| D₉₀ | [mm] | 32.720 |
| D₉₀/D₁₀ | [—] | 13.30 |
| L.A. | [—] | 57 |

The aggregates obtained are no longer monogranular and cannot be used to substitute one part of the aggregate fraction. To be able use them in fresh concrete, the operator would have to separate the aggregates produced by size fraction. Due to the extra work this operation would imply, the aggregates produced ended up being disposed of.

### Example 8

A concrete with the mix design described in table 29 was produced.

TABLE 29
Mix design
Concrete mix design

| | | |
|---|---|---|
| CEM I 52.5 N | [kg/m3] | 350 |
| w/c | [—] | 0.57 |
| 0/4 round | [% agg volume] | 42% |
| 4/8 round | [% agg volume] | 26% |
| 8/12 round | [% agg volume] | 32% |
| Plasticizer | [% mass cement] | 1.70% |
| Retarder | [% mass cement] | 0.35% |

Fresh properties

| | | |
|---|---|---|
| Slump | [cm] | 17.5 |
| Workability class | [—] | S4 |

Part of this concrete was returned to the plant and was pelletized. Table 30 summarizes the pelletizing and curing steps:

TABLE 30
Pelletization and curing Steps
Pellettizing process

| | | |
|---|---|---|
| Pellettizing agent | [kg/m3] | 0.4 |
| Pellettizing time | [min] | 6 |
| Speed of rotation | [1/min] | 14 |

Curing process

| | | |
|---|---|---|
| Curing time | [h] | 16 |
| Curing temperature | [° C.] | 25 |

Tables 31 and 32 summarize the properties of the aggregates produced.

TABLE 31
Particle Size Distribution of the aggregates obtained
Particle Size Distribution

| Sieve | Passing |
|---|---|
| [mm] | [%] |
| 63 | 98.52% |
| 31.6 | 87.74% |
| 20 | 85.63% |
| 16 | 74.12% |
| 14 | 62.40% |
| 12.5 | 54.60% |
| 10 | 51.23% |
| 8 | 47.63% |
| 6.3 | 32.70% |
| 4 | 20.10% |
| 2 | 14.50% |
| 1 | 10.40% |
| 0.5 | 7.80% |
| 0.25 | 6.40% |
| 0.125 | 5.32% |
| 0.063 | 0.00% |

TABLE 32
Parameters obtained for the produced pellets
Aggregates characterization

| | | |
|---|---|---|
| D₁₀ | [mm] | 0.923 |
| D₅₀ | [mm] | 9.317 |
| D₉₀ | [mm] | 38.183 |
| D₉₀/D₁₀ | [—] | 41.36 |
| L.A. | [—] | 48 |

D₉₀/D₁₀ obtained is very high due to the low amount of pelletizing agent used.

1. Method to produce aggregates, comprising the steps of:
(a) adding at least one pelletizing agent to an unsettled cementitious mixture,
(b) mixing constantly the mixture of step (a) in a mixer to produce pellets,
(c) discharging the pellets obtained in step (b) and
(d) drying the pellets formed in step (c).

2. Method according to claim 1, wherein said method is to produce coarse aggregates and wherein the method comprises the steps of:
(a) adding at least one pelletizing agent to an unsettled cementitious mixture,
(b) mixing constantly the mixture of step (a) in a mixer to produce pellets,
(c) discharging the pellets obtained in step (b) to form a pile,
(d) drying the pellets formed in step (c) for a curing time of minimum t1 to maximum t2 depending on the curing temperature according to the following equations:
t1=A×e^{-0.047×T(° C.)}
t2=B×e^{-0.047×T(° C.)}
wherein A is a parameter from 50 to 55, B is a parameter from 75 to 80 and T(° C.) represents the curing temperature in Celsius degrees
and
(e) transforming the pile into a bed of dried pellets.

3. Method according to claim 1, wherein the solid active content of the pelletizing agent is at a concentration in the range of 0.2 to 10 kg/m³ with respect to the unsettled cementitious mixture.

4. Method according to claim 3, wherein the solid active content of the pelletizing agent is at a concentration in the range of 0.8 to 10 kg/m³ with respect to the unsettled cementitious mixture.

5. Method according to claim 1, wherein the pelletizing agent in step (a) is selected from the group consisting of cellulose, chitosan, collagen, polyacrylamide and co-polymers of polyacrylamide and polyacrylics, polyamines, polyvinylalcohols, polysaccharides, lactic acid, methacrylic acid, methacrylate, hydroxyethyl, ethylene glycol, ethylene oxide, acrylic acid, inorganic flocculants and inorganic coagulants.

6. Method according to claim 1, wherein the pelletizing agent is acrylamide-based.

7. Method according to claim 1, wherein the water-to-cement ratio of said unsettled cementitious mixture is between 0.15 and 1.5.

8. Method according to claim 1, wherein in step (b) mixing is carried out for 1 to 25 minutes.

9. Method according to claim 8, wherein mixing is carried out for 4 to 15 minutes.

10. Method according to claim 8, wherein mixing is carried out for 5 to 15 minutes.
